(19) United States
(12) Patent Application Publication
(10) Pub. No.: US 2012/0170929 A1
(43) Pub. Date: Jul. 5, 2012

(54) Apparatus And Method For Monitoring An Optical Coherent Network

(76) Inventors: Chongjin Xie, Morganville, NY (US); Robert William Tkach, Little Silver, NJ (US)

(21) Appl. No.: 12/983,419

(22) Filed: Jan. 3, 2011

(51) Int. Cl. H04B 10/08; H04B 17/00

(52) U.S. Cl. 398/33; 398/25; 398/30

(57) ABSTRACT

An example method determines at an optical network monitoring device whether a value for at least one parameter that characterizes an optical signal which traverses a link of an optical coherent network is above a corresponding threshold and sets an alarm indicator when the value is larger than the corresponding threshold. The at least one corresponding parameter is at least one of polarization mode dispersion, polarization dependent loss and chromatic dispersion. An example method may obtains the optical signal from the link of the coherent optical network and determines the value for the at least one parameter, which may entail calculating the value based on the optical signal and filter coefficients of a filter that can be utilized to compensate the optical signal. In another embodiment, the value for the at least one parameter is received from a monitoring unit that determined the value from the optical signal

### FIELD OF INVENTION

This invention relates to monitoring for an optical network, and in particular to apparatuses and methods for monitoring for an optical coherent network.

### DESCRIPTION OF RELATED ART

As is well known, an optical signal may have two orthogonal polarization states, each of which may have different properties. Sometimes such polarization states are intentionally introduced, such as in creating a polarization-multiplexed signal in which the two orthogonal polarization states of the optical carrier are arranged so that each carries different data in order to double the spectral efficiency. Such a polarization-multiplexed signal has two so-called “generic” polarization components, each of which carries a single data modulation. Note that by a generic polarization component it is generally intended the signal at the point at which the modulation of that polarization component is completed. It should be appreciated that each generic polarization component may initially, or otherwise, exist separate from the other generic polarization component with which it is later combined. It should also be appreciated that the phase of the generic need not be constant.

Polarization-division-multiplexed optical communication systems using digital coherent detection are promising candidates for use in high speed optical networks. Coherent detection is utilized to fully recover the complex field of the received signal, allowing compensation of linear impairments including chromatic dispersion (CD) and polarization-mode dispersion (PMD) using digital filters. In addition, fiber nonlinearities can also be partly compensated by using either some simple nonlinear phase rotations or complex backward propagation in the digital domain.

The polarization orientations of the generic signal components unfortunately are generally changed by the birefringence of the fiber, and possibly other fiber properties, during the passage of the signal over the optical path. Such changes may be time varying because at least the fiber birefringence is typically a function of various factors such as ambient temperature, mechanical stress, and so forth, which may vary over time and be different at various points of the transmission path. As a result, the polarization orientation of each of the generic signal components is generally unknown at the receiver.

Sometimes and undesirably, the fiber birefringence is so large that polarization-mode dispersion (PMD) is caused. In other words, a generic optical signal component is decomposed into two orthogonal polarization components along the two principal state of polarization (PSP) axes of the fiber, along one of which the light travels at its fastest speed through the fiber and along the other of which the light travels at its slowest speed through the fiber. In such a case, not only may the phase relationship between the two polarization components be time varying, but also each of the two orthogonal polarization components may arrive at the receiver at different times due to the PMD-induced differential group delay (DGD) between the two PSP axes. Note that, actually, as suggested above, each small section of the fiber behaves as if it is its own mini fiber that introduces its own DGD between the two PSP axes. Thus, for a particular fiber or optical link, PMD is a stochastic effect, and the PMD-induced DGD may also be time varying.

Optical communication systems also suffer from polarization dependent loss (PDL). PDL mainly comes from optical components such as couplers, isolators and circulators, in which insertion loss is dependent on polarization states of input signals. PDL causes the fluctuation of optical signal-to-noise-ratio (OSNR) and performance differences between the two generic polarization components. PDL is a stochastic phenomenon and PDL-induced penalties may also be time varying.

Other linear effects distort optical signals transmitted over optical fibers. Such effects include chromatic dispersion (CD) which is a deterministic distortion given by the design of the optical fiber. CD leads to a frequency dependence of the optical phase and its effect on transmitted signal scales quadratically with the bandwidth consumption or equivalently the data rate. Optical compensation methods and electrical compensation methods are typically employed to reduce signal distortion that arises due to CD or PMD in direct detection systems and coherent detection systems, respectively.

In prior art polarization-division-multiplexed optical coherent communication systems, transmission impairments, such as chromatic dispersion, polarization-mode dispersion, and polarization dependent loss, may be compensated for electronically using digital signal processing, and polarization demultiplexing of the generic polarizations may also performed in the electrical domain by digital signal processing.

### SUMMARY

One example method includes determining at an optical network monitoring device whether a value for at least one parameter that characterizes an optical signal which traverses a link of an optical coherent network is above a corresponding threshold and setting an alarm indicator when the value is larger than the corresponding threshold. The at least one corresponding parameter is at least one of polarization mode dispersion, polarization dependent loss and chromatic dispersion.

In one embodiment, the method also obtains the optical signal from the link of the coherent optical network and determines the value for the at least one parameter. Determining the value may include calculating the value based on the optical signal and filter coefficients of a filter that can be utilized to compensate the optical signal. In another embodiment, the value for the at least one parameter is received from a monitoring unit that determined the value for the optical signal. In yet another embodiment, the value for polarization mode dispersion or chromatic dispersion is calculated based on detected states of polarization of pilot tones in the optical signal or detected phase or RF power of pilot tones in the optical signal.

The method may include generating display information for displaying the value via a user interface. The display information may be displayed on the user interface in an embodiment.

The method may include generating an alarm corresponding to the alarm indicator. The alarm may be a visible alarm, an audible alarm, a message forwarded to an interested party and the like or a combination thereof. In another embodiment, an event record including at least one of the value, the alarm indicator and the corresponding threshold is stored to a memory device. Thereafter, a report may be generated based on a plurality of event records stored in the memory device.

One example apparatus includes a memory and a controller. The memory is configured to store a value for at least one parameter that characterizes an optical signal that traverses a link of a coherent optical network, the at least one parameter being at least one of polarization mode dispersion, polarization dependent loss and chromatic dispersion. The controller is configured to determine whether the value is above a corresponding threshold for the at least one parameter and setting an alarm indicator when the value is larger than the corresponding threshold.

In one embodiment, the apparatus includes a monitoring unit configured to accept at least a portion of the optical signal and to determine the value for the at least one parameter based on the optical signal. The monitoring unit may be configured to determine the value as a function of the optical signal and filter coefficients of a filter that can be utilized to compensate the optical signal. In another embodiment, a monitoring unit receives the value of the at least one parameter from a monitoring apparatus that calculates the value based on the optical signal. In yet another embodiment, the monitoring unit may be configured to determine the value for polarization mode dispersion or chromatic dispersion is calculated based on detected states of polarization of pilot tones in the optical signal or detected phase or RF power of pilot tones in the optical signal.

In one embodiment, the controller may be configured to determine display information for displaying the value via a user interface. Thus, in another embodiment, the apparatus includes an associated display unit for displaying the display information provided by the controller.

An example embodiment may include an alarm unit for generating an alarm, wherein the controller is configured to activate the alarm unit based on the alarm indictor. In on embodiment, the controller is configured to generate an alarm corresponding to the alarm indicator, with the alarm being at least one of a visible alarm, an audible alarm, and a message forwarded to an interested party. An example apparatus may include a memory device for storing an event record including at least one of the value, the alarm indicator and the corresponding threshold. A report generator may be included for generating a report based on a plurality of event records.

In one embodiment, a system includes a monitoring device having a controller configured to set an alarm indicator when a value for at least one parameter that characterizes an optical signal that traverses a link of a coherent optical network is above a corresponding threshold, the at least one parameter being at least one of polarization mode dispersion, polarization dependent loss and chromatic dispersion; and an optical coherent receiver. The system may also include an optical coherent transmitter.

### BRIEF DESCRIPTION OF THE DRAWINGS

Other aspects, features, and benefits of various embodiments of the invention will become more fully apparent, by way of example, from the following detailed description and the accompanying drawings, in which:

FIG. 1 is an illustration of an example optical coherent network;

FIG. 2a is an illustration of an example embodiment of a monitoring apparatus according to one or more principles of the invention and implemented in a stand-alone device arranged between an optical transmitter and an optical coherent receiver;

FIG. 2b is an illustration of monitoring apparatus according to one or more principles of the invention and implemented by a digital signal processor of an optical coherent receiver;

FIG. 3 is a schematic illustration of an example monitoring apparatus; and

FIG. 4 is an illustration of an example method for monitoring a link of an optical coherent system according to one or more principles of the invention.

### DETAILED DESCRIPTION

As mentioned above, the performance of optical networks can be degraded by many factors (i.e., parameters), such as noise, fiber nonlinearities, chromatic dispersion (CD), polarization-mode dispersion (PMD), and polarization-dependent loss (PDL). To manage high capacity, large scale optical networks, it is essential for network operators to monitor these parameters in the optical networks. These parameters can be used for signal impairment assessment, fault localization, routing, et al. For the proper operation of optical networks, network operators not only need to know these parameters of their optical network, but also need to know the range of the parameters that their network can tolerate as well. Therefore, it is important for system vendors to provide such information in their network products.

PMD is considered as one of the limiting factors in high-speed optical transmission systems. As noted, optical digital coherent detection has recently emerged as a promising technology for optical networks. One of the advantages of digital coherent detection is that linear impairments including CD and PMD, in principle, can be completely compensated in the electrical domain by digital signal processing if electronic equalizers in coherent receivers are complex enough. PDL induced crosstalk between two generic polarizations in a polarization-multiplexed signal can also be eliminated. Therefore, conventional thought does not consider CD and PMD to be a problem in optical digital coherent detection systems, and considers large PDL to be toleratable in optical digital coherent detection systems.

However, in reality, the complexity of electronic equalizers is limited, and thus the CD and PMD, and PDL that an optical coherent receiver can handle (i.e. compensate for) is also limited. Moreover, for a polarization-division-multiplexing (PDM) coherent receiver, once the system PMD is larger than a certain value, the system penalty will increase sharply and the system bit error rate (BER) will immediately increase to unacceptable level. If a system has a larger PMD value than that can be compensated by the coherent receiver, the system will fail and the network operators may not be able identify the cause of the failure. This is also true for CD and PDL. Therefore, monitoring the BER to detect anomalies as undertaken by conventional monitoring and monitoring apparatuses will not provide information, with respect to a coherent optical system, that can be acted upon proactively before a failure occurs.

In general, in one embodiment is provided a monitoring and warning apparatus for monitoring CD, PMD or PDL or a combination thereof for an optical coherent system. The monitoring and warning apparatus may be implemented as a stand-alone specialized computer device (i.e., a particular machine) or may be implemented by a processor in a receiver for an optical coherent system. For example, the monitoring and warning apparatus may be configured to monitor CD, PMD and PDL in a link of an optical coherent system. CD, PMD and PDL limit values and/or associated thresholds may be set according to the parameters for an associated coherent receiver (e.g., coefficients of filter/s of a coherent receiver). The monitoring and warning apparatus may be configured to monitor CD, PMD and PDL in a link of an optical coherent system, display the monitored CD, PMD and PDL value in the system and the preset CD, PMD and PDL limit values that the coherent receiver can compensate. When the monitored CD, PMD and PDL are within a close to the corresponding limit values (e.g., within a threshold of the corresponding limit value), an alarm will be indicated (e.g., an alarm sound). When the system fails, by checking that the monitored CD, PMD and PDL are close to the corresponding limit values of the system, the operator can be assisted in determining whether the system failure is caused by CD, PMD or PDL.

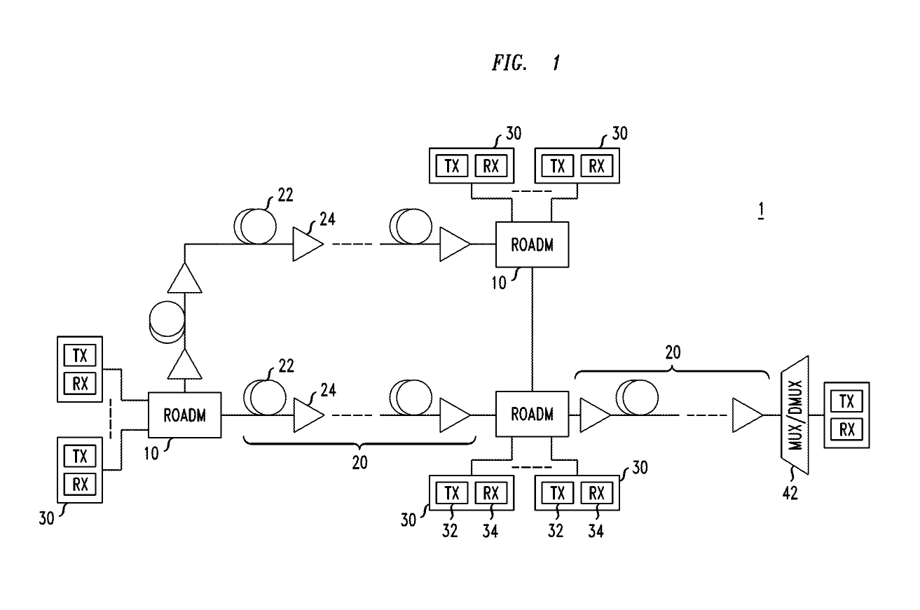

FIG. 1 is an illustration of an example optical coherent network. In an optical coherent network 1, a number of network nodes, usually referred to as add/drop multiplexers (ADM), are connected. In FIG. 1, ADM are reconfigurable optical add-drop multiplexer (ROADM) 10. A ROADM is a form of optical add-drop multiplexer that adds the ability to remotely switch traffic from a wavelength-division-multiplexing system at the wavelength layer. This is achieved through the use of a switching module. This allows individual or multiple wavelengths carrying data channels to be added and/or dropped from a transport optical fiber without the need to convert the signals on all of the WDM channels to electronic signals and back again to optical signals.

ROADM 10 are connected over links 20 comprising one or more fiber spans 22 which may include pre or post amplification by an amplifier 24. Connected to a ROADM are one or more access nodes (AN) 30. A ROADM will receive traffic from a corresponding AN and insert the traffic onto the optical coherent network. Similarly, a ROADM will remove traffic destined to one of its connected ANs and forward the traffic to its destination. Each AN includes a transmitter 32 for sending traffic and a receiver 34 for receiving traffic. An AN may be directly connected to a ROADM or ROADM may send traffic across a link to delivered to an access node. The traffic may be multiplexed/demultiplexed 42 for transport between a ROADM and corresponding AN.

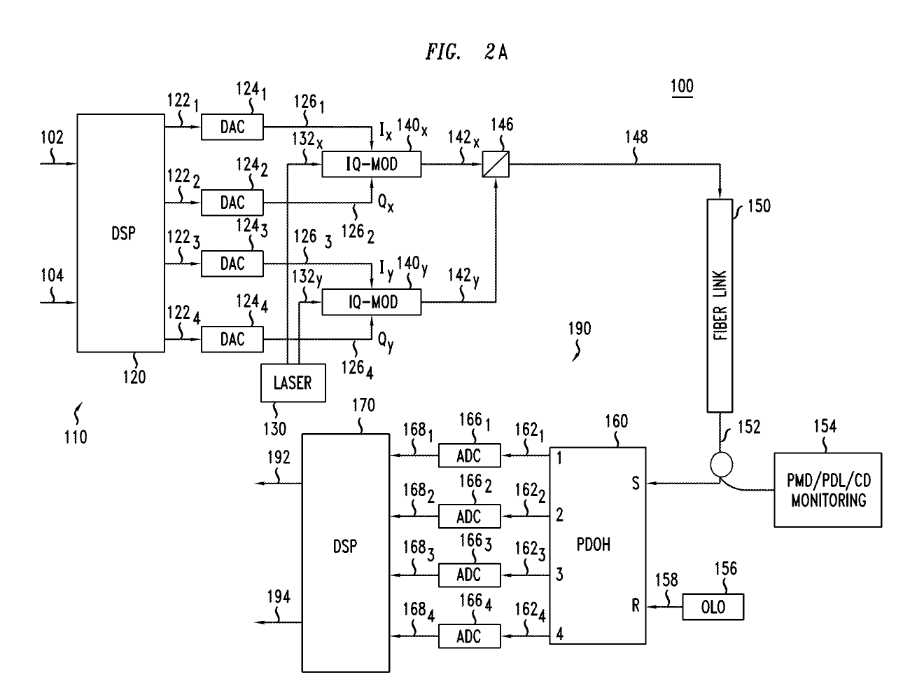

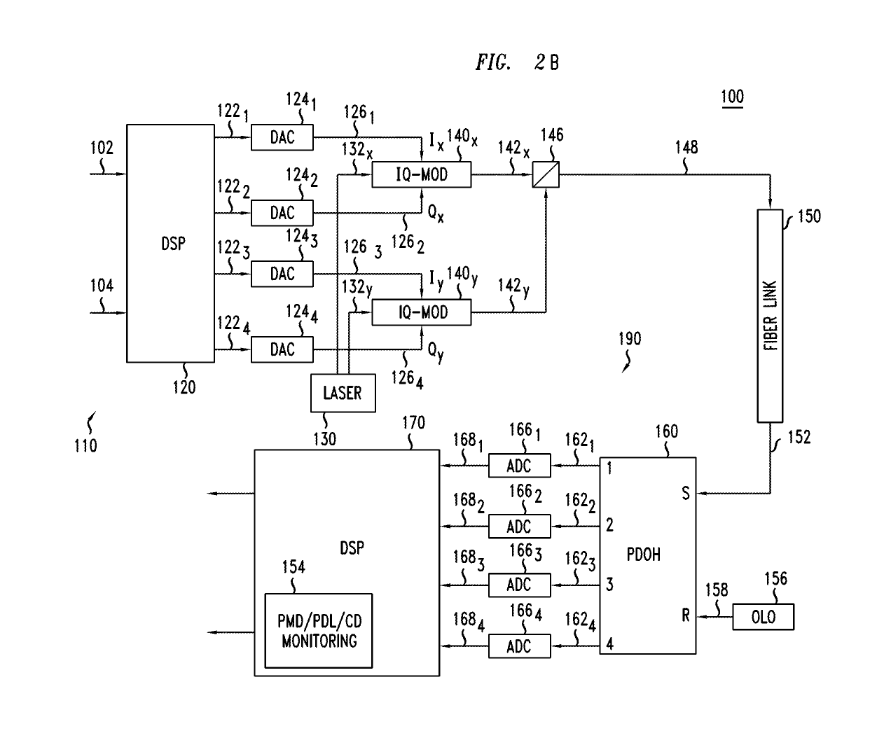

FIG. 2a is an illustration of an example embodiment of a monitoring apparatus according to one or more principles of the invention and implemented in a stand-alone device arranged between an optical transmitter and an optical coherent receiver. System 100 has an optical transmitter 110 and an optical receiver 190 connected via a fiber link 150. In one embodiment, fiber link 150 is an amplified fiber link having one or more optical amplifiers (not explicitly shown in FIG. 2a).

Transmitter 110 receives two independent data streams 102 and 104 for transmission to receiver 190. A digital-signal processor (DSP) 120 processes data streams 102 and 104 to generate digital signals 122₁-122₄. In particular, processor 120 processes input data stream 102 to generate digital output signals 122₁ and 122₂ and input data stream 104 to generate digital output signals 122₃ and 122₄. In a representative embodiment, processor 120 is implemented using two processors configured to operate in parallel to one another. Input data stream 102 is applied to a coding module of the processor 120, where it is optionally interleaved and subjected to forward-error-correction (FEC) coding. A coded bit stream produced by coding module is applied to a constellation-mapping module, where it is converted into a corresponding sequence of constellation symbols. The constellation used by constellation-mapping module can be, for example, a QAM (Quadrature Amplitude Modulation) constellation or a QPSK (Quadrature Phase Shift Keying) constellation. The symbol sequence is applied to a framing module, where it is converted into a corresponding sequence of data frames. The frame sequence produced by framing module is then applied to a pulse-shaping module, where it is converted into output signals 122₁ and 122₂.

Digital signals 122₁-122₄ undergo a digital-to-analog conversion in digital-to-analog converters (DACs) 124₁-124₄, respectively, to produce drive signals 126₁-126₄. Drive signals 126₁ and 126₂ are in-phase (I) and quadrature-phase (Q) drive signals, respectively, corresponding to data stream 102. Drive signals 126₃ and 126₄ are similar in-phase and quadrature-phase drive signals corresponding to data stream 104.

An optical IQ modulator 140_{X} uses drive signals 126₁ and 126₂ to modulate an optical-carrier signal 132_{X} generated by a laser source 130 and to produce a modulated signal 142_{X}. An optical IQ modulator 140_{Y} similarly uses drive signals 126₃ and 126₄ to modulate an optical-carrier signal 132_{Y} generated by laser source 130 and to produce a modulated signal 142_{Y}. A polarization beam combiner 146 combines modulated signals 142_{X} and 142_{Y} to produce an optical polarization-division-multiplexed (PDM) signal 148. Note that optical-carrier signals 132_{X} and 132_{Y} have the same carrier frequency. Each of drive signals 126 can be amplified by an RF amplifier (not explicitly shown) before being applied to drive the corresponding optical IQ modulator 140.

Fiber link 150 receives signal 148 from beam combiner 146 for transmission to receiver 190. While propagating through fiber link 150, signal 148 is subjected to various transmission impediments, such as chromatic dispersion (CD), polarization mode dispersion (PMD), polarization dependent loss (PDL), and emerges at the receiver end of the fiber link as an optical signal 152. Tap 152 directs a portion of the optical signal to monitoring apparatus 154 for monitoring of a value for at least one parameter that characterizes the optical signal which traverses the link. The at least one corresponding parameter is at least one of polarization mode dispersion, polarization dependent loss and chromatic dispersion. When the value is above a corresponding threshold for the parameter, the monitoring apparatus sets an alarm indicator.

Receiver 190 has an optical-to-electrical (OLE) converter 160 having (i) two input ports labeled S and R and (ii) four output ports labeled 1 through 4. Input port S receives optical signal 152. Input port R receives an optical reference signal 158 generated by an optical local oscillator (OLO) 156. Reference signal 158 has substantially the same optical-carrier frequency (wavelength) as signal 152. Reference signal 158 can be generated, e.g., using a tunable laser controlled by a wavelength-control loop (not explicitly shown in FIG. 1) that forces an output wavelength of the tunable laser to substantially track the carrier wavelength of signal 152. In various embodiments, optical local oscillator 156 may comprise a combination of tunable and/or non-tunable lasers, optical frequency converters, optical modulators, and optical filters appropriately connected to one another to enable the generation of reference signal 158.

O/E converter 160 mixes input signal 152 and reference signal 158 to generate eight mixed optical signals (not explicitly shown in FIG. 1). O/E converter 160 then converts the eight mixed optical signals into four electrical signals 162₁-162₄ that are indicative of complex values corresponding to the two orthogonal-polarization components of signal 152. For example, electrical signals 162₁ and 162₂ may be an analog in-phase signal and an analog quadrature-phase signal, respectively, corresponding to an x-polarization component of signal 152. Electrical signals 162₃ and 162₄ may similarly be an analog in-phase signal and an analog quadrature-phase signal, respectively, corresponding to a y-polarization component of signal 152.

In one embodiment, O/E converter 160 is a polarization-diverse 90-degree optical hybrid (PDOH) with four balanced photo-detectors coupled to its eight output ports. Various suitable PDOHs are commercially available, e.g., from Optoplex Corporation of Fremont, Calif., and CeLight, Inc., of Silver Spring, Md.

Each of electrical signals 162₁-162₄ generated by O/E converter 160 are converted into digital form in a corresponding one of analog-to-digital converters (ADCs) 166₁-166₄. Optionally, each of electrical signals 162₁-162₄ may be amplified in a corresponding amplifier (not explicitly shown) prior to the resulting signal being converted into digital form. Digital signals 168₁-168₄ produced by ADCs 166₁-166₄ are processed by a digital signal processor 170 to recover the data applied by data streams 102 and 104 to transmitter 110. In particular, the processor 170 processes the digital form of detected output signals in order to recover the data carried by the modulated carriers corresponding to a single carrier or multi-carrier optical signal. The DSP processes the modulated carriers to perform impairment compensation and carrier separation and recovery. In a representative embodiment, the processor 170 is further configured to compensate for transmission impairments such as chromatic dispersion, PMD, and self-phase modulation. Thus, the DSP may include at least one of a dispersion compensation module, a constant modulus algorithm (CMA) based blind equalization module and/or decision-directed least mean square (LMS) equalization module, a self-phase modulation (SPM) compensation module, a carrier separation module if a multi-carrier signal is received, a frequency estimation and compensation module, a phase estimation and compensation module, a demodulation module, and a data recovery module for processing the received single carrier or multi-carrier optical signal. Note that the named modules perform the processing necessary to implement the stated name of the module. For example, the dispersion compensation module performs dispersion compensation on the carriers being processed, the data recovery module recovers the data carried by the modulated carrier, etc.

The recovered data are outputted from receiver 190 via output signals 192 and 194, respectively.

FIG. 2b is an illustration of monitoring apparatus according to one or more principles of the invention and implemented by a digital signal processor of an optical coherent receiver. As illustrated monitoring apparatus 154 for monitoring of a value of the polarization mode dispersion, polarization dependent loss or chromatic dispersion characterizing the optical signal which traversed the link is a part of the receiver digital signal processor.

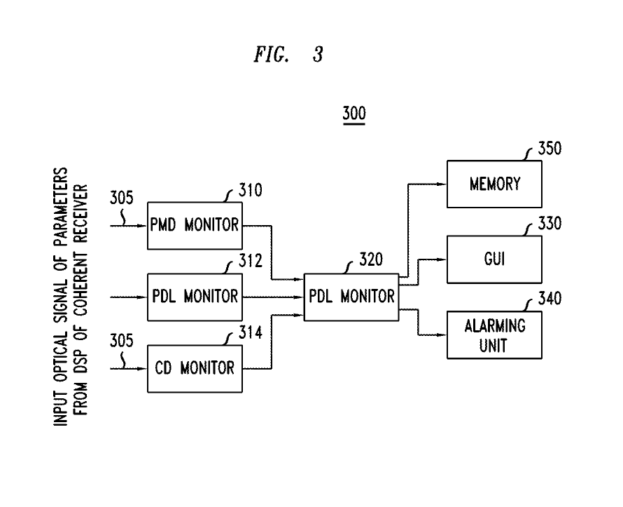

FIG. 3 is a schematic illustration of an example monitoring apparatus. Monitoring apparatus 300 includes at least one of a polarization mode dispersion monitor 310, a polarization dependent loss monitor 312 or a chromatic dispersion monitor 314. Each monitor determines a value for corresponding parameter that characterizes an optical signal which traversed a link. The value may be determined based on an input optical signal 305. For example, the value may be calculated as a function of the optical signal and filter coefficients of a filter that can be utilized to compensate the optical signal.

For instance, PMD and PDL can be determined or estimated from the equalizer parameters of a coherent receiver as disclosed in U.S. patent application Ser. No. 12/827,473 (filed Jun. 30, 2010); C. Xie et al, Two-Stage Constant Modulus Algorithm Equalizer for Singularity Free Operation and Optical Performance Monitoring in Optical Coherent Receiver, OFC'2010, paper OMK3, 2010; and J. C. Geyer et al, Channel Parameter Estimation for Polarization Diverse Coherent Receivers, PTL Vol. 20, No. 10, May 15, 2008, all of which are incorporated herein by reference in their entirety.

One embodiment of a standalone monitoring apparatus that is not implemented a part of a receiver may have elements similar to the receiver (190 of FIG. 2(b)), with the exception that one or more DSP modules, above described, for processing the digital form of detected output signals in order to recover the data carried by the modulated carriers corresponding to the optical signal are not required.

In another embodiment, with pilot tones having been added at the transmitter, a value for PMD can be determined/estimated by detecting states of polarization of the pilot tones or by detecting the phase or RF power of the pilot tones.

For instance, CD can be either determined or estimated from the equalizer parameters of a coherent receiver as disclosed in J. C. Geyer et al, Channel Parameter Estimation for Polarization Diverse Coherent Receivers, PTL Vol. 20, No. 10 May 15, 2008; or can be determined/estimated from detecting the phase difference between a few pilot tones or detecting the phase or RF power of the pilot tones as disclosed in B. Fu et al, Fiber Chromatic Dispersion and Polarization-Mode Dispersion Monitoring Using Coherent Detection, PTL Vol. 17, No. 7, July 2005; and F. N. Khan et al, Chromatic Dispersion Monitoring using Coherent Detection and Tone Power Measurement, OECC'2009, paper ThLP74, 2009., all of which are incorporated herein by reference in their entirety.

In another embodiment, a monitoring unit (e.g., PMD monitor 310, PDL monitor 312, or CD monitor 314) receives the value 305 of the at least one parameter from a monitoring apparatus that calculated the value based on the optical signal.

Once determined, the value is provided to controller 320 for comparison with a corresponding threshold for the subject parameter (i.e., PMD threshold, PDL threshold, or CD threshold). The controller sets an alarm indicator when the value for the parameter is above a corresponding threshold. CD, PMD and PDL limit values and/or associated thresholds may be set according to the parameters for an associated coherent receiver (e.g., coefficients of filter/s of a coherent receiver). The corresponding thresholds may be established in conjunction with CD, PMD and PDL limit values associated with the coherent receiver's abilities for provide compensation. When the monitored CD, PMD and PDL are within a close to the corresponding limit values (e.g., within a threshold of the corresponding limit value), an alarm will be indicated.

In one embodiment, the controller may be configured to determine display information for displaying the value via a user interface. Thus, the monitoring apparatus includes an associated display unit 330 (e.g., graphical user display) for displaying the display information provided by the controller. The monitoring apparatus may also include an alarm unit 340 for generating an alarm, wherein the controller is configured to activate the alarm unit based on the alarm indictor. The alarm activated by the alarming unit may be a visible alarm, an audible alarm, a message forwarded to an interested party, and like ways of alerting an interested party to the occurrence of the alarm. The monitoring apparatus may also include a memory device for storing an event record relates to its activities. For example, an event record or for any parameter may include the determined value, an associated alarm indicator, the corresponding threshold or any combination thereof. The controller may also include a report generator in order that a report can be generating based on a plurality of stored event records. When the optical coherent system or a link of the system fails, by checking whether the monitored CD, PMD and PDL are close to the corresponding limit values of the system, the operator can be assisted in determining whether the system failure is caused by CD, PMD or PDL.

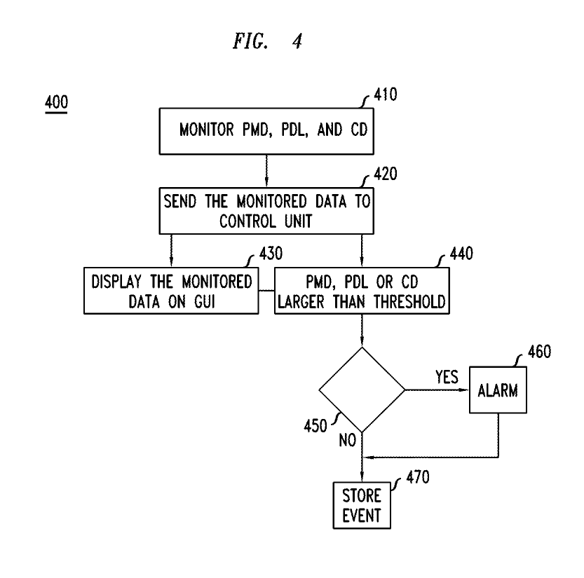

FIG. 4 is an illustration of an example method 400 for monitoring a link of an optical coherent system according to one or more principles of the invention. At step 410, the methodology begins by monitoring a value of at least one of PMD, PDL or CD for an optical signal that traverses a link of an optical coherent network. At step 420, the monitored data is sent to/received at the control unit (i.e., controller) of a monitoring device.

At step 430, the controller generates display information for displaying the value via a user interface and the display information is relates to the monitored value is displayed on a user interface. The CD, PMD and PDL monitoring apparatus may monitor CD, PMD and PDL in real time, and the user interface show those monitored values and the CD, PMD and PDL limits that the coherent receiver has. For example, the monitored values may be illustrated in histogram form with thresholds also illustrated and color bands indicated thresholds approached and/or reached. This information tells network operators how far their system operates from the CD, PMD and PDL limits.

At step 440, the value of the PMD, PDL or CD characterizing the optical signal compared to a corresponding threshold. At step 450, it is determined if the value of the PMD, PDL or CD characterizing the optical signal is above a corresponding threshold.

If the value is larger than the corresponding threshold, at step 460 an alarm indicator is set and alarm may be provided to display for an interested user. This step may include generating an alarm corresponding to the alarm indicator. The alarm may be a visible alarm, an audible alarm, a message forwarded to an interested party and the like or a combination thereof. If the value is not larger than the corresponding threshold, an alarm is not given. There may be a plurality of thresholds for any one parameter such that a corresponding plurality of alarm may be indicated.

At step 460, an event record relates to the monitoring of the link is stored. An event record may include the value, the alarm indicator, or the corresponding threshold, or any combination thereof is stored to a memory device. Thereafter, reports may be generated based on a plurality of event records stored in the memory device.

Note that the controller of the monitoring apparatus is a logical module that may be realized as an independent physical unit (e.g., specially programmed computer) or as part of an optical coherent receiver. In the latter case, a number of embodiments are possible. For example, in one embodiment, the software that supports the controller may be administratively configured. In another embodiment, each optical coherent receiver may include a monitor for determining the value of the at least one parameter (i.e., CD, PMD, PDL, or a combination thereof) and the values from a plurality of optical coherent receivers provided to a monitoring apparatus, for example, one at a command center.

In the simplest embodiment, the monitoring apparatus is an independent physical unit, such as a computer comprising a processor and memory, with direct link to each optical coherent receiver for the reception of values for the appropriate parameter.

While this invention has been described with reference to illustrative embodiments, this description is not intended to be construed in a limiting sense.

Embodiments of present invention may be implemented as circuit-based processes, including possible implementation on a single integrated circuit.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the following method claims, if any, recite steps in a particular sequence with corresponding labeling, unless the claim recitations otherwise imply a particular sequence for implementing some or all of those steps, those steps are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The embodiments covered by the claims are limited to embodiments that (1) are enabled by this specification and (2) correspond to statutory subject matter. Non-enabled embodiments and embodiments that correspond to non-statutory subject matter are explicitly disclaimed even if they formally fall within the scope of the claims.

The description and drawings merely illustrate principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor/s to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures, including any functional blocks labeled as “processors”, “controllers” or “modules” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” or “module” should not be construed to refer exclusively to hardware capable of executing software, and may implicitly include, without limitation, digital signal processor (DSP) hardware, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

What the claimed is:

1. A method comprising:
determining at an optical network monitoring device whether a value for at least one parameter that characterizes an optical signal which traverses a link of an optical coherent network is above a corresponding threshold; and
setting an alarm indicator when the value is larger than the corresponding threshold;
wherein the at least one corresponding parameter is at least one of polarization mode dispersion, polarization dependent loss and chromatic dispersion.

2. The method of claim 1 further comprising:
obtaining the optical signal from the link of the coherent optical network; and
determining the value for the at least one parameter.

3. The method of claim 2 wherein determining the value comprises:
calculating the value based on the optical signal and filter coefficients of a filter that can be utilized to compensate the optical signal.

4. The method of claim 2 wherein determining the value comprises:
calculating the value for polarization mode dispersion or chromatic dispersion based on detected states of polarization of pilot tones in the optical signal or detected phase or RF power of pilot tones in the optical signal.

5. The method of claim 1 further comprising:
receiving the value for the at least one parameter from a monitoring unit that determined the value for the optical signal.

6. The method of claim 1 further comprising:
generating display information for displaying the value via a user interface.

7. The method of claim 6 further comprising:
displaying the display information on the user interface.

8. The method of claim 1 further comprising:
generating an alarm corresponding to the alarm indicator, the alarm being at least one of a visible alarm, an audible alarm, a message forwarded to an interested party.

9. The method of claim 1 further comprising:
storing an event record including at least one of the value, the alarm indicator and the corresponding threshold to a memory device.

10. The method of claim 9 further comprising:
generating a report based on a plurality of event records stored in the memory device.

11. An apparatus comprising:
a memory for storing a value for at least one parameter that characterizes an optical signal that traverses a link of a coherent optical network, the at least one parameter being at least one of polarization mode dispersion, polarization dependent loss and chromatic dispersion; and
a controller for determining whether the value is above a corresponding threshold for the at least one parameter and setting an alarm indicator when the value is larger than the corresponding threshold.

12. The apparatus of claim 11 further comprising:
a monitoring unit configured to accept at least a portion of the optical signal and to determine the value for the at least one parameter based on the optical signal.

13. The apparatus of claim 12 wherein the monitoring unit is configured to determine the value as a function of the optical signal and filter coefficients of a filter that can be utilized to compensate the optical signal.

14. The apparatus of claim 12 wherein the monitoring unit is configured to determine the value for polarization mode dispersion or chromatic dispersion based on detected states of polarization of pilot tones in the optical signal or detected phase or RF power of pilot tones in the optical signal.

15. The apparatus of claim 11 further comprising:
a monitoring unit for receiving the value of the at least one parameter from a monitoring apparatus that calculates the value based on the optical signal.

16. The apparatus of claim 11 wherein the controller is configured to determine display information for displaying the value via a user interface.

17. The apparatus of claim 16 further comprising;
an associated display unit for displaying the display information;
wherein the controller is configured to provide the display information to the associated display unit.

18. The apparatus of claim 11 further comprising:
an alarm unit for generating an alarm;
wherein the controller is configured to activate the alarm unit based on the alarm indictor.

19. The apparatus of claim 11 wherein the controller is configured to generate an alarm corresponding to the alarm indicator, the alarm being at least one of a visible alarm, an audible alarm, and a message forwarded to an interested party.

20. The apparatus of claim 11 further comprising:
a memory device for storing an event record including at least one of the value, the alarm indicator and the corresponding threshold.

21. The apparatus of claim 11 further comprising:
a report generator for generating a report based on a plurality of event records.

22. A system comprising:
a monitoring device comprising
a controller configured to set an alarm indicator when a value for at least one parameter that characterizes an optical signal that traverses a link of a coherent optical network is above a corresponding threshold, the at least one parameter being at least one of polarization mode dispersion, polarization dependent loss and chromatic dispersion; and
an optical coherent receiver.

23. The system of claim 22 further comprising:
an optical coherent transmitter.
